(19) United States
(12) Patent Application Publication
(10) Pub. No.: US 2012/0199258 A1
(43) Pub. Date: Aug. 9, 2012

(54) TIRE WITH ASYMMETRIC GROOVE BOTTOM FOR SHOULDER GROOVE

(75) Inventors: William Bennett Clayton, Simpsonville, SC (US); Susan Marie Nelson, Greenville, SC (US)

(73) Assignees: SOCIETE DE TECHNOLOGIE MICHELIN, Clermont-Ferrand (FR); MICHELIN RECHERCHE ET TECHNIQUE S.A, Granges-Paccott (CH)

(21) Appl. No.: 13/499,306

(22) PCT Filed: Oct. 19, 2009
(86) PCT No.: PCT/US09/61152

§ 371 Date: Mar. 30, 2012

(51) Int. Cl. B60C 11/117

(52) U.S. Cl. 152/209.18

(57) ABSTRACT

A tire with a shoulder groove that has an asymmetric bottom is provided and, more particularly, a tire is provided having a shoulder groove that includes features at the bottom of the groove that help reduce stress and alleviate cracking from tire operation. The reduction is accomplished without the addition of material to the groove bottom.

### FIELD OF THE INVENTION

The present invention relates to a tire with a shoulder groove that has an asymmetric bottom and, more particularly, to a tire having a shoulder groove that is provided with features at the bottom of the groove that help reduce stress and alleviate cracking from tire operation.

### BACKGROUND OF THE INVENTION

When a tire rolls across a surface, a deformation occurs particularly in the portion at and near the contact with the surface. Conventional understanding is that as the tire continues to roll, this deformation repeats and creates a cyclical field of compressive stress and strain in the tire. Because this cycling can fatigue the material and lead to unwanted cracks, it presents a particular problem that tire designers have approached by focusing on the compressive stress and strain at and near the tire's contact with the road surface.

Certain tire tread patterns have a groove defined in the tread and extending circumferentially around the tire at a position adjacent to the tire's shoulder—i.e., a shoulder groove. Because of its location between the more rigid summit of the tire and the more flexible sidewall portion of the tire, the shoulder groove is frequently a location of increased opportunity for stress concentrations that can lead to longitudinal cracking of the rubber materials used to make the tire. More particularly, as rubber compounds have been shown to crack in mode 1, crack development in the shoulder groove is expected to be dependent upon the Cauchy stress at the bottom of the groove.

Material can be added into the groove to provide reinforcement against cracking along the groove bottom. However, if the addition of such material results in a reduction in the size of the groove, the capacity of the groove to pass water away from the contact surface of the tire during operation in e.g., rainy weather can be unfavorably reduced.

Therefore, a design for a shoulder groove that helps reduce cracking from cyclical stress and strains would be useful. A design for a shoulder groove that can be readily incorporated into the overall tread pattern of a tire without necessarily changing the overall appearance of the tread pattern would also be useful. These and other advantages will be apparent from the description of the present invention that follows below.

### SUMMARY OF THE INVENTION

Aspects and advantages of the invention will be set forth in part in the following description, or may be obvious from the description, or may be learned through practice of the invention.

In one exemplary embodiment, the present invention provides a tire having a tread and a shoulder, the tire defining circumferential, radial, and axial directions, and the tread defining an inferior tread profile. The tire includes at least one groove formed into a surface of the tread with the groove extending about the circumferential direction of the tire. The groove is positioned adjacent to the shoulder and inward thereof along the axial direction.

The groove includes, as viewed in a meridian plane of the tire, at least four portions. A first linear portion extends radially-inward to a depth D1 from the exterior tread surface. A second linear portion extends radially-inward to a depth D2 from the tread surface, with depth D1 being greater than depth D2. The first linear portion is located between the second linear portion and the shoulder of the tire. A third linear portion is connected to, and extends radially-inward from, an end of the second linear portion. The third linear portion is positioned at an angle θ from a hypothetical line that is collinear with the second linear portion. The angle θ represents the amount by which the third linear portion is angled away from the shoulder. A fourth curvilinear portion forms the radially innermost surface of the at least one groove. The fourth curvilinear portion extends between and connects the first linear portion and the third linear portion. The fourth curvilinear portion includes an arc of an ellipse.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a cross-section view, along the meridian plane, of a tire tread portion having an exemplary embodiment of a shoulder groove of the present invention.

FIG. 2 provides a schematic, cross-sectional view along the meridian plane of an exemplary embodiment of a shoulder groove of the present invention. FIG. 2 includes one or more parameters used in describing aspects of the invention as will be set forth below.

FIG. 3 provides a close-up of the groove bottom of FIG. 2. FIG. 3 also includes one or more parameters used in describing aspects of the present invention as will be set forth below.

FIG. 4 provides an illustration of the arc of an ellipse and parameters that may be used in defining the arc as set forth below.

FIGS. 5 through 8 provide data plots from certain modeling results as will be described below.

### DETAILED DESCRIPTION OF THE INVENTION

The present invention provides a tire with a shoulder groove having an asymmetric bottom and, more particularly, to a tire having a shoulder groove that is provided with features at the bottom of the groove that help reduce stress and alleviate cracking from tire operation. For purposes of describing the invention, reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention covers such modifications and variations as come within the scope of the appended claims and their equivalents.

“Equatorial Plane” means a plane that passes perpendicular to the tire axis of rotation and bisects the tire structure.

“Meridian Plane” means a plane that passes through and includes the axis of rotation of the tire.

“Inferior Tread Profile” means a line of constant radius that is tangent to at least the groove bottom of the shoulder grooves of the tire.

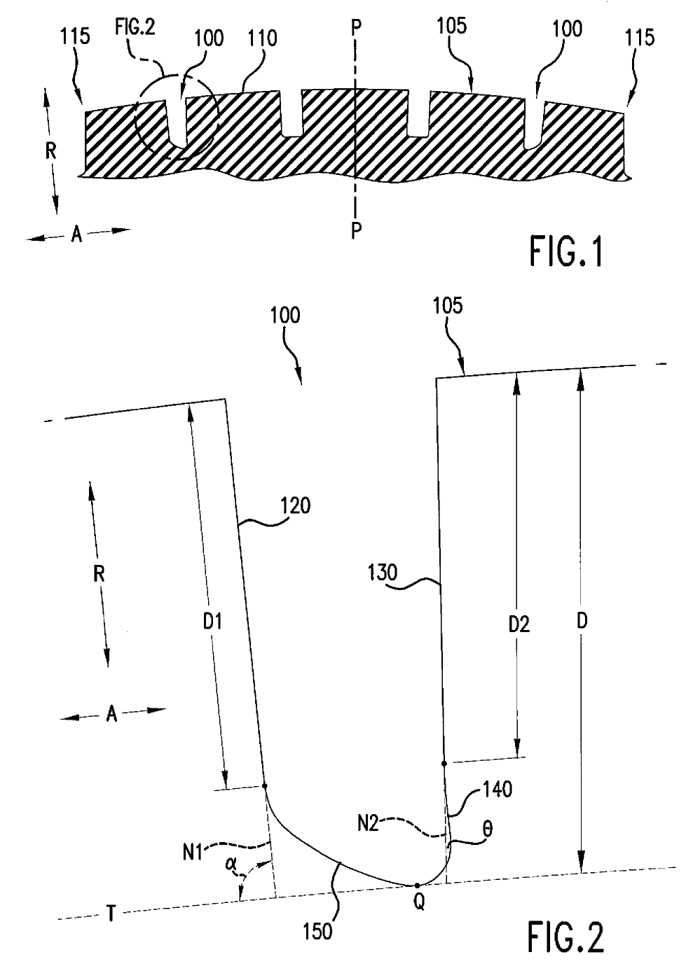

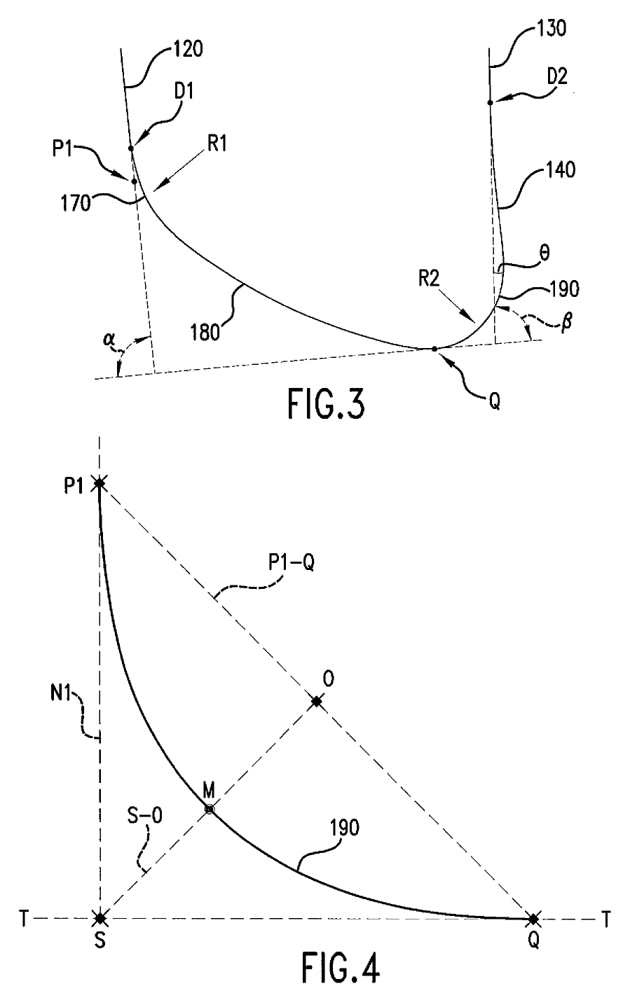

FIGS. 1 and 2 illustrate an exemplary embodiment of a shoulder groove 100 of the present invention. More particularly, tread 110 includes two shoulder grooves 100 where each such groove 100 extends circumferentially around the tire. Each shoulder groove 100 is located adjacent to a shoulder 115 of the tire and inward thereof along the axial direction A. By axially inward, it is meant that on each side of tread 110, each groove 100 is located in a direction moving along the axial direction A towards the central equatorial plane P from a respective shoulder 115. FIGS. 2 and 3 represent one such shoulder groove 100 along one side of tread 105—it being understood that the pair of shoulders 115 are symmetrical about the equatorial plane P.

For this exemplary embodiment, groove 100 is constructed from four different portions 120, 130, 140, and 150. Each portion provides a wall or surface extending along the circumferential direction of the tread 110. When viewed in the meridian plane as shown in FIGS. 2 and 3, these portions appear as lines and will be so described here with the understanding that such lines represent surfaces along the circumferential direction. For example, a straight line represents a surface that extends around the circumferential direction of the tread.

First linear portion 120 is represented as a straight line that extends radially-inward from the exterior tread surface 105—i.e., toward the axis of rotation of the tire and generally along radial direction R but not necessarily parallel thereto. Point D1 marks the depth (or length) of first linear portion 120 along the radial direction R. First linear portion 120 is oriented at an angle α to the inferior tread profile T and represents a wall along one side of shoulder groove 100. N1 and N2, shown in phantom and collinear with portions 120 and 130, are virtual or hypothetical lines used in the illustrations for purposes of describing the invention.

Second linear portion 130 also appears in the meridian plane as a straight line that extends radially-inward from the exterior tread surface 105. Point D2 marks the depth of second linear portion 130 along the radial direction R. Second linear portion 130 is oriented at an angle β to the inferior tread profile T and represents another wall along one side of shoulder groove 100. As shown by comparing FIGS. 1 and 2, first linear portion 120 is located between second linear portion 130 and shoulder 115. In addition, the depth D2 of second linear portion 130 is less than the depth D1 of first linear portion.

Depths D1 and D2 can be expressed as percentages of the overall depth D of shoulder groove 100. While other values may be used with the present invention, preferably depth D1 is the range of about 78.5 to about 82.5 percent of depth D and, even more preferably, depth D1 is about 80 percent of depth D. Again, while other values may be used, depth D2 is preferably about 77.5 percent of depth D. Angles α and β are values that are specified by the tire designer depending upon e.g., the intended tire application. Such values for angles α and β can vary along the circumferential direction. As a result, the values for other parameters of the invention can also vary circumferentially provided such values meet the applicable values or ranges specified herein. It should also be understood that surfaces along the groove 100—such as e.g., first and second linear portions 120 and 130—can be interrupted along the circumferential direction by various other tread features that might also be used with the tire.

Third linear portion 140 is represented as a straight line that connects to second linear portion 130 at depth D2. Portion 140 extends radially-inward from second linear portion 130. The value of angle θ represents the amount by which third linear portion 140 is angled away from hypothetical line N2 in a direction away from a respective shoulder 115 of the tire and towards the central equatorial plane P. While other values may be used with the present invention, preferably angle θ is in the range of about 0 degrees to about 10 degrees and, even more preferably angle θ is about 5 degrees.

Fourth portion 150 is curvilinear and provides the radially innermost surface of groove 100. Portion 150 extends from first linear portion 120 to third linear portion 140 and connects between these two portions. As shown in the figures, fourth curvilinear portion 150 provides an asymmetric shape for the bottom of groove 100. With reference to FIG. 3, the shape of fourth portion 150 can be described with reference to three different components 170, 180, and 190. The size and positioning of these three sections along with the values for angle θ and depths D1 and D2 relative to the overall groove depth D controls the shape or asymmetry of groove 100.

First circular arc 170 is connected to the first linear portion 120 at its radially innermost end located at depth D1. Having a radius R1, arc 170 is positioned tangent to first linear portion 120 and tangent to an arc of an ellipse 180. Accordingly, first circular arc 170 is bi-tangent to first linear portion 120 and to the arc of an ellipse 180. While other values may be used with the present invention, preferably radius R1 is about 2 mm

Second circular arc 190 is connected to third linear portion 140 and has a radius R2. Second circular arc 190 is also bi-tangent in that it is positioned tangent to both third linear portion 140 and to the arc of an ellipse 180. While other values may be used with the present invention, preferably radius R2 is in the range of about 1.5 mm to about 2.5 mm and, in certain embodiments, is about 1.5 mm.

The arc of an ellipse 180 connects to both first circular arc 170 and second circular arc 190 and spans between the same. The arc of an ellipse 180 represents the shape of the surface forming the bottom-most portion of shoulder groove 100. The position of the arc of an ellipse 180 is also fixed by its tangency. More particularly, the arc of an ellipse is tangent to the hypothetical line N1 at point P1 and is also tangent to the inferior tread profile T at point Q.

The shape of the arc of an ellipse 180 is determined with reference to a parameter c that will be described using FIG. 4. Parameter c describes the degree of curvature of the arc of an ellipse and is defined using a ratio. First, a hypothetical line P1-Q is constructed from the point of tangency of the ellipse 180 with hypothetical line N1 at point P1 to the point of tangency of the ellipse 180 with the inferior tread profile T at point Q. Next, a hypothetical line S-O is constructed from point S to point O. Point S represents the intersection of line N1 with the inferior tread profile T. Hypothetical line S-O is constructed perpendicular to hypothetical line P1-Q. The intersection of hypothetical line S-O with the ellipse is denoted as point M. Accordingly, parameter c is defined as the ratio of M-O to S-O. While other values may be used with the present invention, preferably parameter c is in the range of about 0.220 to 0.325 and, for certain embodiments, preferably has a value of about 0.225.

In order to evaluate the effectiveness of the asymmetry of shoulder groove 100, tire models were constructed and examined using finite element analysis. More specifically, tires were modeled in a fully loaded condition of 3856 kilograms at 7.2 bar and travelling at 90 km/hour. The tires were modeled to determine the maximum Cauchy stress along fourth curvilinear portion 150 as a tire makes a full rotation about its axis. Contrary to conventional wisdom, it was discovered that the maximum Cauchy stress did not necessarily occur at the bottom of the tire at or near the contact region with the road surface due to compressive Cauchy stresses. Instead, the maximum Cauchy stress sometimes occurred as an unexpected tensile stress at or near the top of the tire during operation. Discovering that the largest Cauchy stress can be a tensile stress at the top of the tire, informed the design of the groove bottom of the present invention.

Accordingly, using finite element analysis as discussed above, FIG. 5 represents a plot of the maximum Cauchy stress incurred during a revolution of the tire as function of position along the groove bottom—i.e. along fourth curvilinear portion 150. A position at zero along the x-axis represents the beginning of curvilinear portion 150 at depth D1 with increasing values representing movement towards the end of curvilinear portion 150 at depth D2. The reference values (Ref) represents a plot of the Cauchy stress for a groove bottom that uses a maximum radius of curvature to connect first and second linear portions 120 and 130 between points D1 and D2 (FIG. 3). The Example of Design values represent a plot of Cauchy stress for a shoulder groove 100 where D1=0.8, R1=2.0 mm, parameter c=0.225, R2=1.5 mm, θ=5 degrees, and D2=0.775. As shown in FIG. 5, this exemplary embodiment of the present invention dramatically reduces the Cauchy stress experienced along the fourth curvilinear portion 150 of shoulder groove 100.

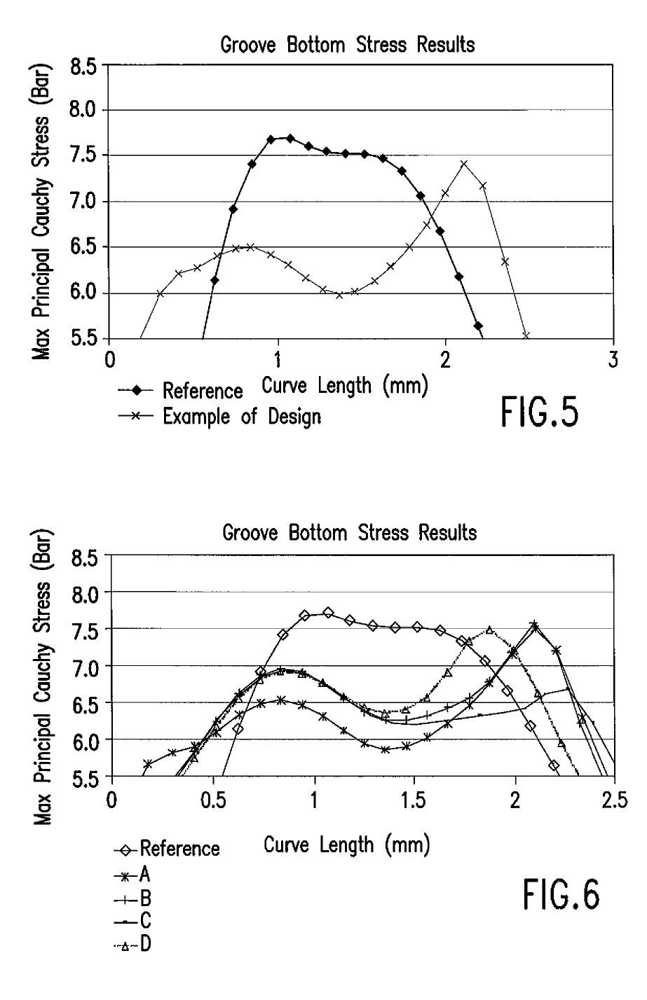

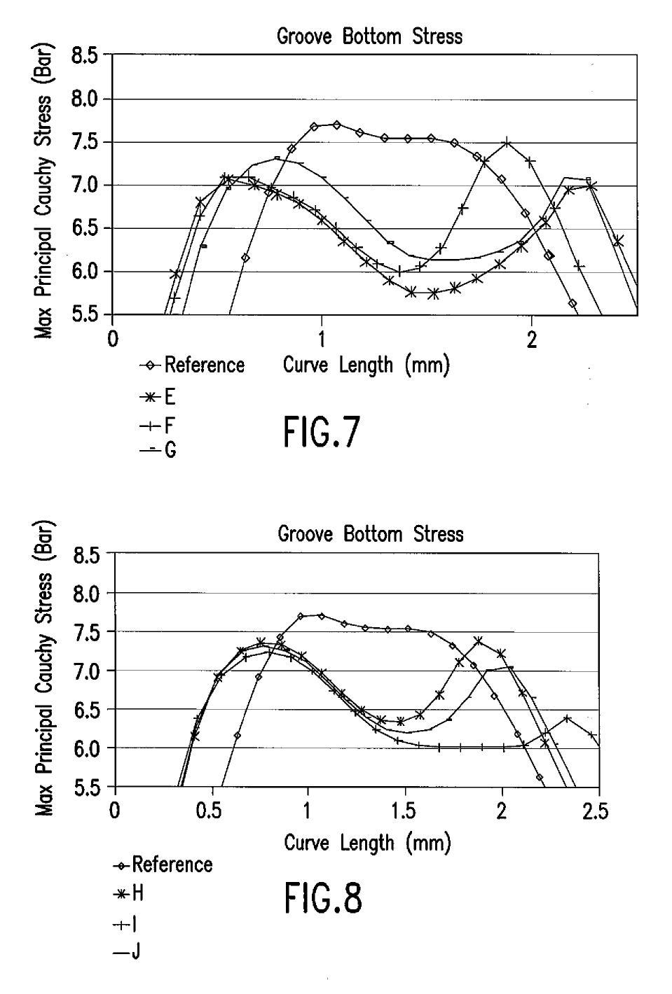

FIGS. 6, 7, and 8 show the results of additional analysis where the parameters D1, C, θ, and R2 were varied while D2 was held constant at 0.775 and R1 was held constant at 2.0 mm. As shown in these plots, the present invention can be used to reduce the Cauchy stress over a range of values as set forth above. Table 1 provides a legend for plots shown in FIGS. 6, 7, and 8.

TABLE 1

| Legend | P1 | C | Theta | R2 |
|---|---|---|---|---|
| A | 785 | 220 | 10 | 1.5 |
| B | 785 | 325 | 0 | 1.5 |
| C | 785 | 325 | 10 | 1.5 |
| D | 785 | 325 | 10 | 2.5 |
| E | 825 | 220 | 10 | 1.5 |
| F | 825 | 220 | 10 | 2.5 |
| G | 825 | 325 | 0 | 1.5 |
| H | 825 | 325 | 0 | 2.5 |
| I | 825 | 325 | 10 | 1.5 |
| J | 825 | 325 | 10 | 2.5 |

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. By way of example, first and second linear portions 120 and 130 are each shown in the figures as a single line segment that extends directly from the exterior tread surface 105. However, linear portions 120 and/or 130 could each be constructed from e.g., more than one line segment connected between the exterior tread surface 105 and depths D1 or D2, respectively. Such additional line segment(s) might form a different angle with hypothetical lines N1 and/or N2 while still providing overall for a first or second linear portion 120 and/or 130 that extends—albeit by more than one line segment—from the exterior tread surface 105. In addition, portions 120 and 130 could also be provided in other configurations such as curvilinear as well. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A tire having a tread and a shoulder, the tire defining circumferential, radial, and axial directions, the tread defining an inferior tread profile, the tire comprising:
at least one groove formed into a surface of the tread, said groove extending about the circumferential direction of the tire;
said groove positioned adjacent to the shoulder and inward thereof along the axial direction;
said groove comprising, as viewed in a meridian plane of the tire, at least the following portions:
a first portion extending radially-inward to a depth D1 from the exterior tread surface;
a second portion extending radially-inward to a depth D2 from the tread surface, wherein depth D1 is greater than depth D2, and wherein the first portion is located between the second portion and the shoulder of the tire;
a linear third portion connected to, and extending radially-inward from, an end of the second portion, the third portion being positioned at an angle θ from a hypothetical line that is collinear with the second portion, wherein angle θ represents the amount by which the third portion is angled away from the shoulder; and,
a curvilinear fourth portion forming the radially innermost surface of the at least one groove, the fourth portion extending between and connecting the first portion and the third portion, the fourth portion comprising an arc of an ellipse.

2. A tire as in claim 1, wherein the fourth portion further forms a first circular arc of radius R1 that is connected to the first portion at a radially-innermost end of the first portion, wherein the first circular arc is positioned tangent to the first portion.

3. A tire as in claim 2, wherein the fourth portion further forms a second circular arc of radius R2 that is connected to the third portion at a radially-innermost end of the third portion, and wherein the second circular arc is positioned tangent to the third portion.

4. A tire as in claim 3, the tire defining an inferior tread profile, wherein the arc of an ellipse of the fourth portion further connects the first circular arc and the second circular arc, wherein the arc of an ellipse is tangent to the first circular arc and tangent to the inferior tread profile.

5. A tire as in claim 4, wherein said groove has an overall depth of D, and wherein the depth D1 is in the range of about 78.5 to about 82.5 percent of depth D.

6. A tire as in claim 4, wherein said groove has an overall depth of depth D, wherein the depth D1 is about 80 percent of depth D.

7. A tire as in claim 4, wherein the radius R1 is about 2 mm.

8. A tire as in claim 4, wherein the radius R2 is between about 1.5 mm and about 2.5 mm.

9. A tire as in claim 4, wherein the angle θ is in the range of about 0 degrees to about 10 degrees.

10. A tire as in claim 4, wherein the angle θ is about 5 degrees.

11. A tire as in claim 4, wherein said groove has an overall depth of D, and wherein the depth D1 is in the range of about 78.5 to about 82.5 percent of the depth D, and wherein the depth D2 is about 77.5 percent of the depth D.

12. A tire as in claim 4, wherein the ellipse has a parameter c value in the range of about 0.220 to about 0.325.

13. A tire as in claim 4, wherein said groove has an overall depth of depth D, and wherein the depth D2 is about 77.5 percent of the depth D.

14. A tire as in claim 4, wherein the angleθ is greater than zero.

15. A tire as in claim 14, wherein said groove has an overall depth of D, and wherein the depth D1 is in the range of about 78.5 to about 82.5 percent of the depth D

16. A tire as in claim 15, wherein said groove has an overall depth of D, and wherein the depth D2 is about 77.5 percent of the depth D.

17. A tire as in claim 1, wherein the ellipse has a parameter c value in the range of about 0.220 to about 0.325.

18. A tire as in claim 1, wherein as viewed in a meridian plane of the tire, the first portion is constructed as a single, straight-line segment that extends from the exterior tread surface to the depth D1.

19. A tire as in claim 18, wherein as viewed in a meridian plane of the tire, the second portion is constructed as a single, straight-line segment that extends from the exterior tread surface to the depth D2.
